(19) United States
(12) Patent Application Publication
(10) Pub. No.: US 2006/0081518 A1
(43) Pub. Date: Apr. 20, 2006

(54) Contaminated liquids filtering apparatus

(76) Inventors: Philip W. Yee, Stockton, CA (US); Skipper K. Yee, Stockton, CA (US)

Correspondence Address: INTELLECTUAL PROPERTY LAW GROUP LLP, 12 SOUTH FIRST STREET, SUITE 1205, SAN JOSE, CA, 95113, US

(21) Appl. No.: 10/965,973

(22) Filed: Oct. 15, 2004

(51) Int. Cl. B01D 35/147

(52) U.S. Cl. 210/90; 210/323.2; 210/456

(57) ABSTRACT

A filtering apparatus comprising an elongate container body, an inlet, an inlet reservoir, an outlet, an outlet reservoir, and at least two filter elements, wherein each filter units contains two or more space-apart and co-axially stacked filter elements encased in a cylindrical-shaped filter cartridge. Contaminated fluid flows from the inlet, through the perforations located on the inlet reservoir separator, and into the elongate container body. Fluid flows into the filter units through perforations in the filter cartridge and the open ends of the filter cartridge. The filter units use an opposed axial flow method to draw the fluid through the filter elements. The filtered fluid flows through a perforation in the axial conduit, passes through the axial conduit outlet into the outlet reservoir. The filtered fluid then exits through the outlet. The present invention may be used in operation with a motor and pump to filter large flow rates and volumes of contaminated fluid.

### BACKGROUND OF THE INVENTION

1. Field of the Invention

The present invention relates generally to filtering devices, and more particularly, to a filtering apparatus comprised of a plurality of opposed axial flow filtering elements, each having a plurality of co-axially arranged filtering units.

2. Background of the Invention

Often, by-products of the internal combustion engine, such as acid, moisture, sludge, and dust particles, contaminate the liquid fuel of such an engine. This results in the erosion of the performance of the engine. A filtration method can trap and remove such contaminates from the circulating liquid fuel. Most conventional filters sold on the market use a thin layer of porous membrane or paper. The finer the pores on the filter paper, the greater the amount of contaminants trapped and removed by the filter. Generally, such filters are attached to the internal combustion engine so that the liquid fuel is carried from the engine to the filter where it is filtered and then carried back to the engine in one continuous flow. In addition, conventional filters only allow the contaminated liquid to flow through the filter in a straight-line motion. Thus, such filters require a large surface area, require frequent replacement, and may obstruct the flow of the circulating liquids.

A filtering apparatus is disclosed in U.S. Pat. No. 3,308,956 to Yee et al (the “'956 patent”), Mar. 14, 1967. The '956 patent uses a filtration media, which consists of layers of porous paper tightly coiled along an axial. This arrangement of filtration media increases the surface area available for contaminated liquids to filter through. As a result, more contaminants are trapped because the contaminated liquid passes through multiple layers of filter paper. Furthermore, the increased surface area holds more contaminants, and the filter paper does not have to be replaced as often. The filter paper is made of a thin cellulose fiber. Such material traps particles as small as 0.01 to 0.5 micron. Also, this material absorbs and separates water molecules from oil. The '956 patent describes a method of filtering contaminated liquids using the axial flow principal of fluid movement wherein the oil flows in one direction through a single annular filter element. The filtering method is suitable for bypass filtering of circulating oil in an internal combustion engine. However, it is difficult to adapt such filters to accommodate for other applications where a wide range of flow rates or adjusting for the pressure drop across the filter are desired.

In another filtering apparatus disclosed in U.S. Pat. No. 4,869,820 to Yee (the “'820 patent”), Sep. 26, 1989, an axial flow filter is provided which can be adapted to handle varying flow rates. The '820 patent describes a co-axially stacked filter which consists of two longitudinally and co-axially stacked filtering units, encased in a filtering container. Fluid enters and fills the filtering container. The fluid that enters the lower filtering unit travels upward and is filtered. The fluid that enters the upper filtering unit travels downward and is filtered. The filtered fluid is then collected in a tube that is located at the center of the filtering container, exits the filtering container through an opening at the bottom of the filtering container, and is carried back to the engine. Since the two filtering units are used concurrently, the contaminated liquid is filtered at a higher rate. As a result, the flow of the circulating liquid remains undisturbed. However, the '820 patent is also limited in its ability to filter larger quantities of contaminated fluid.

In order to achieve maximum filtration of the liquids, the volume of liquids in the filtering apparatus must correspond with the flow rate, pressure, and the total volume of the circulating liquids. As the flow rate, pressure, or volume of the circulating fluid increase, the volume of liquids in the filtering apparatus must also increase. The '956 patent is suitable for bypass filtering of circulating oil in a small internal combustion engine, such as those used in cars or motorbikes. Although suitable for its intended use, the '956 patent does not accommodate the greater flow rates of large internal combustion engines, such as those used in boats, aircrafts, locomotives, and jet aircrafts. Additionally, both the '956 and the '820 patent are not suitable for recycling large volume of contaminated liquids or dirty cleaning fluid solvents from a machinery reservoir.

Accordingly, it is a principal object of the invention to provide a filtering apparatus that can accommodate greater flow rates and volume of large internal combustion engines, such as those used in boats, aircrafts, locomotives, and jet aircrafts. Another principal object of the invention provides a filtering apparatus that can better accommodate changes in the pressure of the circulating liquids.

Another principal object of the invention is to provide a filtering apparatus that can efficiently filter large reserves of contaminated liquids in an industrial setting. The present invention can be installed and attached to machines in a factory. Hence, the liquid fuel used by machines and be filtered and reused.

### SUMMARY OF THE INVENTION

According to the present invention there is a filtering apparatus, which comprises an elongate container body, an inlet, an inlet reservoir, an outlet, an outlet reservoir, and two or more filter units. In a preferred embodiment, an upper lid covers and seals the inlet reservoir. The elongate container body has two ends. The inlet reservoir is attached to one end of the elongate container body while the outlet reservoir is attached to the opposite end of the elongate container body. The inlet consists of an opening on the wall surface of the inlet reservoir. The outlet consists of an opening on the wall surface of the outlet reservoir.

The inlet reservoir is separated from the elongate container body by the inlet reservoir separator. There is a plurality of separator perforations located on the inlet reservoir separator. The inlet reservoir has an upper surface and a bottom surface. There are upper flange members attached to the bottom surface of the inlet reservoir separator. Each of these upper flange members makes contact with the top end of an axial conduit.

The outlet reservoir is separated from the elongate container body by the outlet reservoir separator. The outlet reservoir separator has an upper surface and a lower surface. There are lower flange members attached to the upper surface of the outlet reservoir separator. Each of these lower flange members makes contact with the bottom end of the axial conduit.

A central conduit is located within the elongate container body. The central conduit is attached to the outlet reservoir separator and makes contact with the inlet reservoir separator. Hence, the central conduit runs along the entire axial length of the elongate container body. A portion of the central conduit extends through the inlet reservoir separator and into the inlet reservoir. A screw is located on top of that portion of the central conduit, capping of the central conduit. The screw is adjusted to tighten and hold the outlet reservoir separator upon the central conduit.

The elongate container body holds at least two filter units. In the preferred embodiment, there can be three, four, or seven filter units. Each filtering unit includes at least two vertically spaced-apart filter elements encased in a single filter cartridge. In the preferred embodiment, there are four vertically spaced-apart filter elements. In the preferred embodiment, the filter elements are common tissue rolls, i.e. a continuous roll of tissue paper wrapped around a cardboard cylinder. The filter elements is vertically spaced-apart by screen members. In the preferred embodiment, the filter elements are vertically spaced-apart by three layers of metal barbed wire. However, any porous material can be used as screen members.

Each filter unit is encased in a cylindrical-shaped filter cartridge. The filter cartridge may be made of common cardboard paper or similar impermeable material. The filter cartridge has an upper end and a lower end. The filter cartridge is open at its upper and lower ends.

Within each filter unit, the filter elements are aligned along the same hollow axial called an axial conduit. Hence, at least one end of each filter unit is in fluid communication with the fluid contained within the elongate container body. The axial conduit extends from the upper flange member to the lower flange member. Thus, the axial conduit defines an annular flow path from one end of the filter unit to the other.

The upper flange member caps the upper end of the axial conduit and prevents the bypass flow of fluids from the elongate body container into the axial conduit. Axial conduit outlets are formed on the outlet reservoir plate. Each axial conduit is connected to an axial conduit outlet. The lower flange member prevents the bypass flow of fluids from the elongate container body into the outlet reservoir.

In one embodiment of the present invention, there are perforations on the wall surface of the filter cartridge at the locations where two filter elements are spaced-apart by screen members, thus allowing fluid communication at those locations. There is also a plurality of perforations formed on the wall surface of the axial conduit at locations above and below where two filter elements are spaced-apart by screen members. Thus, fluid from the elongate container body enters through the perforations on the wall surface of the filter cartridge, passes through the screen members and enters the filter elements. The fluid is filtered through the filter element and exits through perforations formed on the wall of the axial conduit. The fluid flows through the axial conduit and exits through the axial conduit outlet into the outlet reservoir. The fluid then exits through the outlet located at the bottom surface of the outlet reservoir.

Hence, when the pressure of the circulating liquids fluctuates, the pressure within the filtering apparatus can be controlled by properly selecting the number and size of the openings on the wall of the axial conduit. Also, additional filtering units of different size and/or filter elements can be added to accommodate an increase in fluid volume. Larger or smaller sized units can be accommodated with a larger or smaller sized elongated container body.

These and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 shows a filtering apparatus, according to an embodiment of the present invention.

FIG. 2 shows a larger filtering apparatus, according to an embodiment of the present invention.

FIG. 3 shows a four-unit filtering apparatus, according to an embodiment of the present invention, illustrated in cross-section.

FIG. 4 shows an exploded view cross-section of the filtering apparatus of FIG. 3, with the filter units removed, according to an embodiment of the present invention.

FIG. 5 shows a seven-unit filtering apparatus, illustrated in cross-section according to an embodiment of the present invention.

FIG. 6 shows a top plan, cross sectional view of a seven-unit filtering apparatus, according to an embodiment of the present invention.

FIG. 7 shows a top plan, cross sectional view of a four-unit filtering apparatus, according to an embodiment of the present invention.

FIG. 8 shows a top plan, cross sectional view of a three-unit filtering apparatus, according to an embodiment of the present invention.

FIG. 9 shows a cross-sectional view of a double filtering element according to an embodiment of the present invention, illustrated in enlarged cross-section.

FIG. 10 shows an assembly of multiple filtering elements within one filtering unit according to an embodiment of the present invention.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

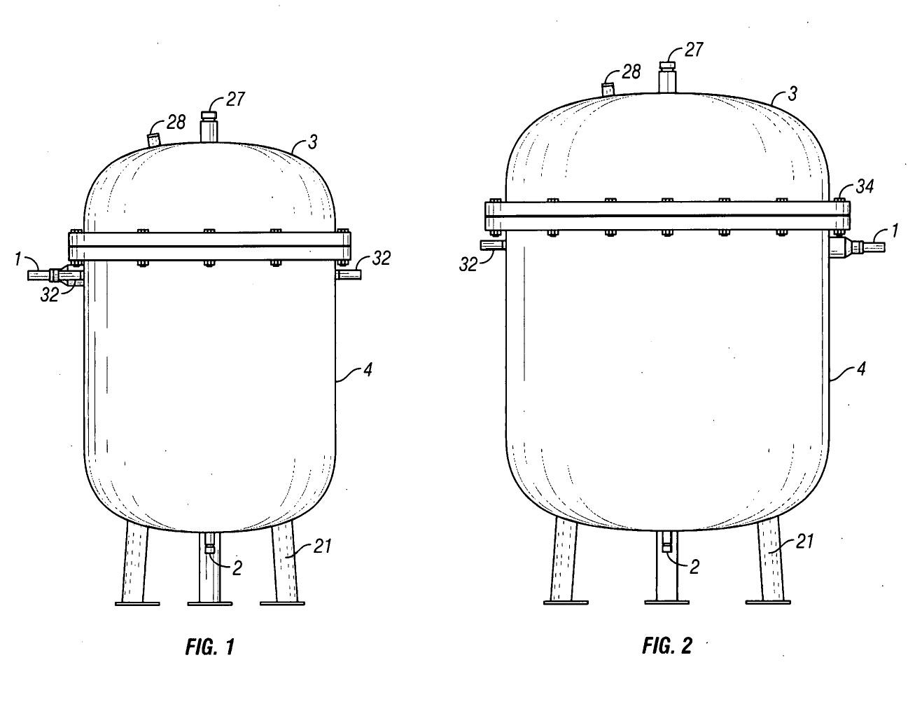

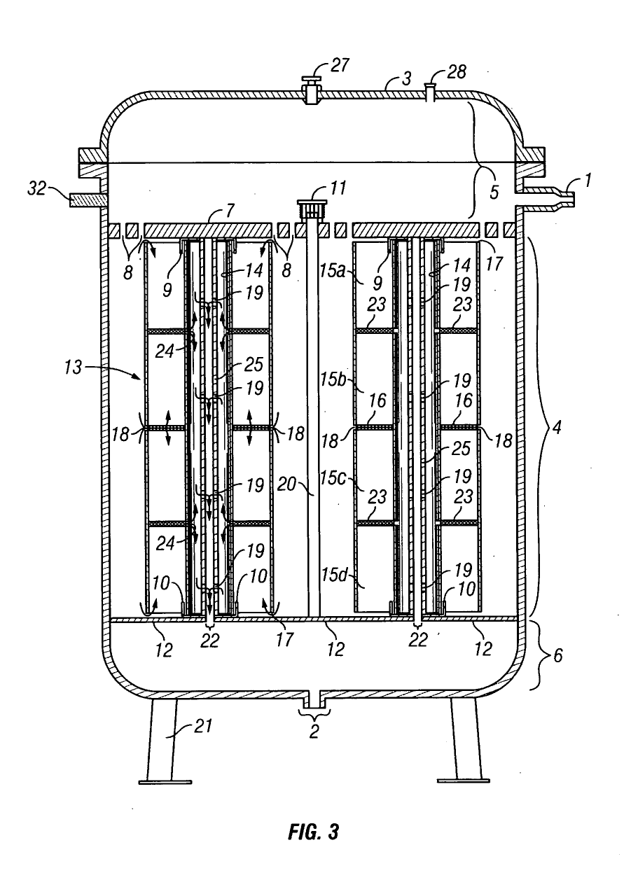

As shown in FIG. 1, a filtering apparatus comprises a removable upper lid 3, an elongate container body 4, an inlet 1, an outlet 2, and two or more filter units 13 situated inside the elongate container body 4. The elongate container body 4 has an upper end and a lower end. As used hereinafter and in the claims, all references to upward and downward directions will be made in reference to the orientation in FIG. 3. In the preferred embodiment, as shown in FIG. 3, there is an inlet reservoir 5 located above the elongate container body 4, and an outlet reservoir 6 located below the elongate container body 4. The inlet reservoir 5 is covered and sealed by the upper lid 3. As shown in FIGS. 1 and 2, the container body 4, essentially cylindrical in shape, may be of different diameters and sizes to accommodate filtering different volume needs. Optional handles 32 on each side of the body 4 are used to facilitate movement of the apparatus. The removable upper lid 3 is clamped or otherwise attached to the body 4 by a connecting means 34, which may include a type of clamp, screw or other fastening means suitable for creating a tight seal of the lid 3 to the body 4. The filter apparatus is composed of metal, preferably aluminum or stainless steel.

Contaminated fluid is pumped through inlet 1, for filtration through the filter units 13, and then flow through outlet 2. The upper lid 3, further includes a pressure regulator 27 having an automatic release valve which releases when pressure increases above a predetermined pressure. The upper lid 3 further includes a gauge 28 which indicates pressure measurement and when a filter unit is saturated and needs to be replaced.

The inlet 1 consists of an opening on the wall surface of the elongate body 4 to the inlet reservoir 5. The outlet 2 consists of an opening on the wall surface of the elongate body 4 to the outlet reservoir 6. The inlet reservoir 5 is separated from the elongate container body 4 by a removable inlet reservoir separator 7. There is a plurality of separator perforations 8 located on the inlet reservoir separator 7. The outlet reservoir 6 is separated from the elongate container body 4 by the outlet reservoir separator 12. The outlet reservoir separator 12 forms a unitary structure with the elongate body 4.

As shown in FIG. 3, central conduit 20 is located within the elongate container body 4. The central conduit 20 extends from the upper surface of the outlet reservoir separator 12 and through the inlet reservoir separator 7 and into the inlet reservoir 5. A screw 11 is located on top of that portion of the central conduit 20, threaded onto the central conduit 20 and applying pressure against the inlet reservoir separator 7, providing a tight seal. Hence, central conduit 20 runs along the entire axial length of the elongate container body 4.

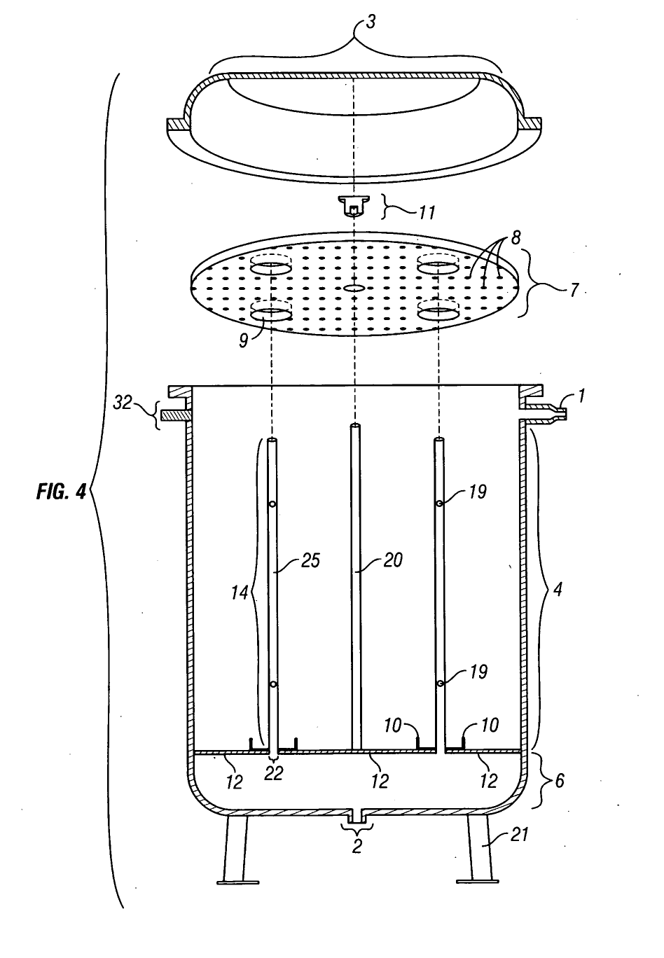

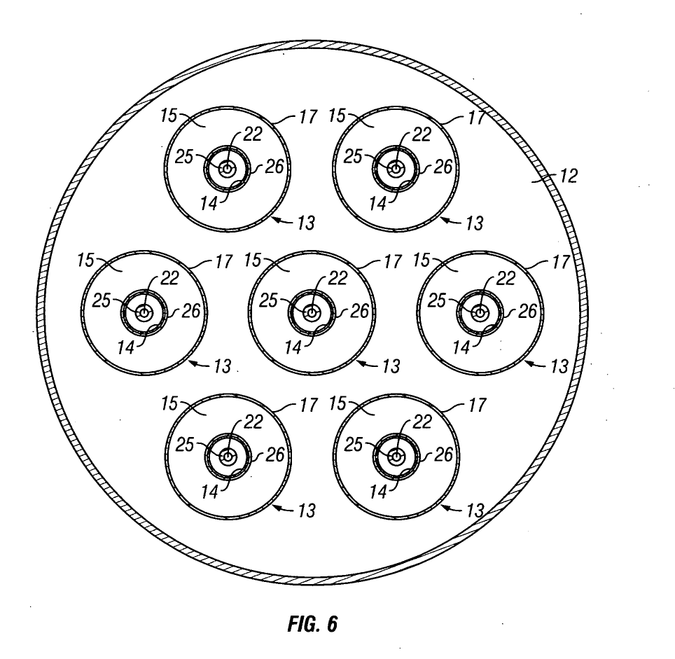

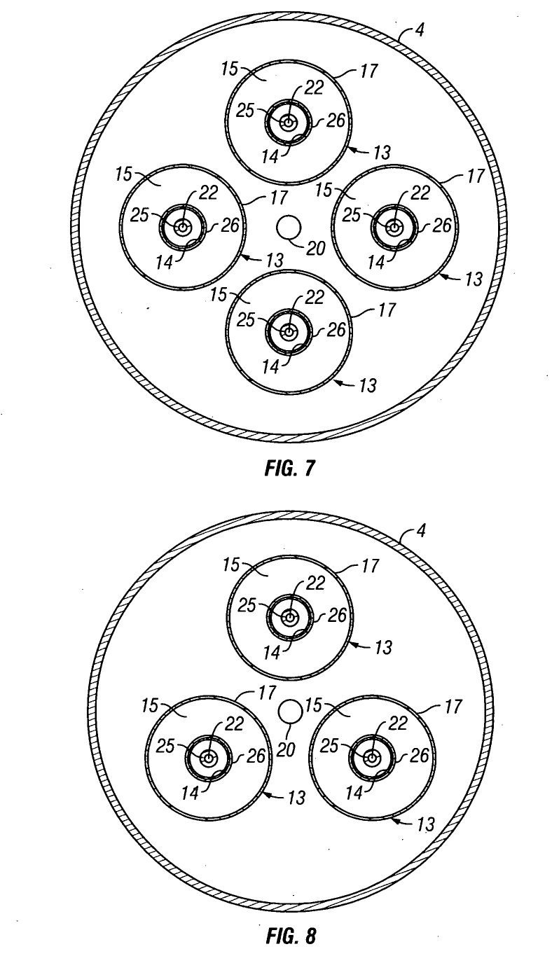

In the embodiment of FIGS. 3 and 4, a plurality of filter units 13, are evenly spaced and positioned in a circle within the elongate container body 4. Each filter unit 13 has an upper end and a lower end. In the preferred embodiment, there are four filter units 13. In other embodiments, there can be seven filter units.13 as shown in FIG. 6 or three filter units 13 as shown in FIG. 8. Additional filtering units 13 of different sizes can be added to accommodate an increase in fluid volume.

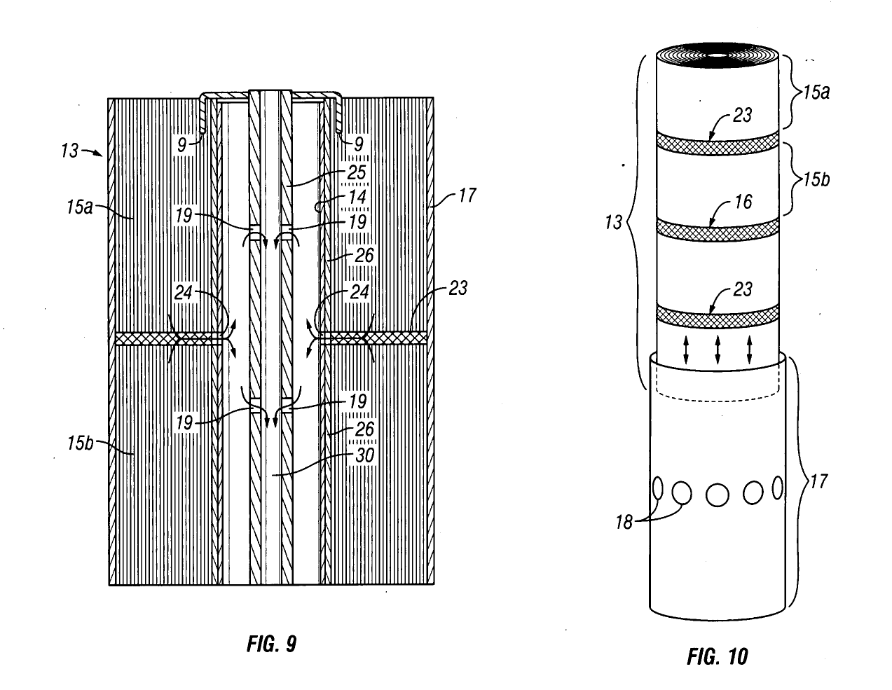

Each filter unit 13 includes two or more filter elements 15 as shown in FIG. 3, that are mounted co-axially with space therebetween inside a cylindrical-shaped filter cartridge 17. FIG. 9, shows an enlarged cross-sectional view of a filter unit 13 with double elements 15. FIG. 10 shows how the filter elements 15 are positioned inside a filter cartridge 17. When the elements are ready for replacement, the entire filter cartridge 17 is removed from the container body 4. Filter cartridge 17 may be made of a thick cardboard like material or cellulose fiber. Each filter cartridge 17 has an upper end and a lower end. The two ends of the filter cartridge 17 are exposed and thus there is fluid communication with filter units 13 at the two ends when in use in the body 4.

In the preferred embodiment, there are four filter elements 15 as shown in FIG. 3. Additional filtering elements 15 can be added to accommodate an increase in fluid volume. In the preferred embodiment, the four filter elements 15 are upper 15a, upper-middle 15b, lower-middle 15c, and lower 15d filter elements.

The upper-middle 15b and lower-middle 15c filter elements 15 are separated by one or more screen members 16. One or more intermediate screen members 23 separate the upper 15a and upper-middle 15b filter elements 15. One or more intermediate screen members 23 separate the lower 15d and lower-middle 15c filter elements 15. In the preferred embodiment, screen members 16 and intermediate screen members 23 are comprised of three layers of barbed wire. The screen members 16 serve as flow paths for incoming fluids. The screen members 23 serve as flow path for exiting fluids.

As shown in FIG. 9, the filter elements 15 are vertically stacked along an axial conduit 14. The filter elements typically of tissue rolls or other absorbent material wound around a cardboard cylinder 26 are situated very closely to the surface of axial conduit 14. As shown in FIG. 3, the axial conduit 14 has an upper end and a lower end. There are upper flange members 9 attached to the bottom surface of the inlet reservoir separator 7. Each of these upper flange members 9 makes contact with the top end of an axial conduit 14, providing a seal against the inlet reservoir separator 7. There are lower flange members 10 attached to the upper surface of the outlet reservoir separator 12. Each of these lower flange members 10 makes contact with the bottom end of the axial conduit 14, proving a seal against the outlet reservoir separator 12. Upper flange members 9 and lower flange members 10 penetrate in part through filter elements situated at the extreme ends for providing a flush seal to prevent bypass flow of unfiltered fluid into the axial conduit 14. Axial conduit 14 includes a plurality of slots 24 at points near the meeting (gap) between filter elements 15a and 15b as well as at points near meeting (gap) between filter elements 15c and 15d for the exit of filtered fluid from the respective filter elements exiting through screen members 23. Thus, filtered fluid is forced into axial conduit through slots 24. Axial conduit 14 surrounds exit tube 25. Exit tube 25 is connected at a lower end to lower flange members 10 and outlet reservoir separator 12 and made flush against upper flange member 9 when screw 11 is tightened on central conduit 20. Exit tube 25 comprises exit perforations 19 of variable size and number for receiving filtered fluid. Hence, exit tube 25 runs along the entire axial length of the elongate container body 4 and defines an annular flow path 30 from one end of the filter unit to the other. Further, the upper flange member 9 prevents bypass flow of fluid from the inlet reservoir into the axial conduit 14 and exit tube 25. Exit outlets 22 are formed on the outlet reservoir plate 12. Each exit tube 25 is connected to an exit outlet 22. The lower flange member 10 prevents the bypass flow of unfiltered fluids from the elongate body container 4 into the outlet reservoir 6.

Filter cartridge perforations 18, as shown in FIG. 10, are formed on the wall surface of the filter cartridge 17 at the locations where two filter elements 15 are spaced-apart by screen members 16, thus allowing fluid communication at those locations. As mentioned a plurality of exit perforations 19, shown in FIGS. 3 and 9, are formed on the wall surface of the exit tube 25 at locations where two filter elements 15 are spaced-apart by intermediate screen members 23.

Thus contaminated fluid enters the filtering apparatus through inlet 1 and collects in inlet reservoir 5. The contaminated fluid flows through the separator perforations 8 that are located on the inlet reservoir separator 7 which serves as a baffle and collects in elongate container body 4. Due to the large amount of fluid to be filtered, the inlet reservoir separator 7 is important in provided an even dispersion of the flow of fluid. Once passing through the separator perforations 8, contaminated fluid enters the filter unit 13 through the upper end, lower end, and the filter cartridge perforations 18. The contaminated fluid that enters filter unit 13 from the upper end will flow downward into filter element 15a. The contaminated fluid that enters filter unit 13 from the lower end will flow upward into filter element 15d. The contaminated fluid that enters filter unit 13 through the filter cartridge perforations 18 will flow pass screen members 16 and flow either upward or downward to filter elements 15b and 15c.

After filtration, the filtered fluid will collect at the intermediate screen members 23 and will flow into axial conduit 14 through the slot 24. The filtered fluid will then flow out of the axial conduit 14 through exit perforations 19 and then flow through exit outlet 22 and into outlet reservoir 6.

Support members 21 extend from the bottom of the outer wall surface of the outlet reservoir 6. In the preferred embodiment, there are three to four support members 21 supporting the filtering apparatus.

The filtering apparatus just described is suitable for filtering a wide variety of fluids. In general, the described filtering apparatus removes particles in order to recycle the fluid. The present invention can remove particles that are the size of cigarette smoke and can also remove water molecules from liquids. Fluids which may be filtered by the present invention include cooking oils, hydraulic fluids, dry cleaning fluids, spent motor oil, water, gasoline, diesel fuel, and the like. After the filtering element 15 has been exhausted, the filter cartridge 17 may be easily removed and replaced.

As shown in FIG. 4, filter units 13 are removed from the axial conduits 14 by removing the lid 3, screw 11, and inlet reservoir separator 7. Thereafter, filter cartridge 17 is removed and a new filter cartridge 17 with clean filter elements 15 is inserted back into each unit 13.

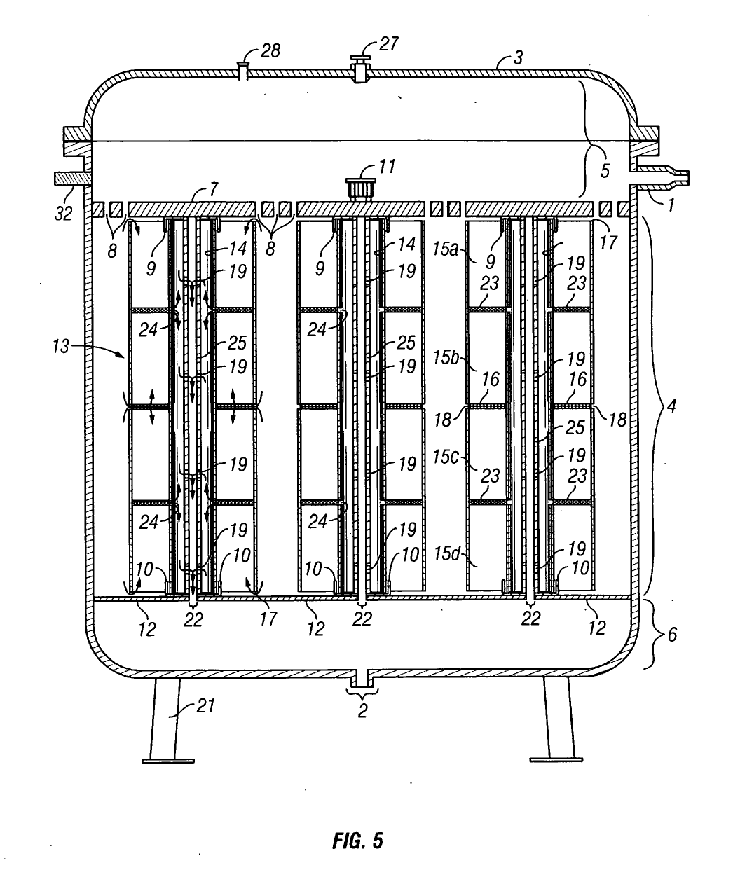

An alternate embodiment of the filtering apparatus of the present invention is illustrated in FIGS. 5 and 6. The filtering apparatus of FIG. 5 includes seven-filtering units 13. The components of such a filter apparatus are generally the same as those described for the embodiment of FIG. 3. However, in the seven-unit embodiment, a filter unit 13 having a plurality of filter elements 15 is positioned in the middle of the container body 4, with six-other filter units 13 symmetrically positioned around said center filter unit 13, see FIG. 6. The center filter unit 13, is essentially stacked along the central conduit 20 (normally found on the 3-unit or 4-unit embodiments), and accordingly serves as an exit tube 25. As such, the center filter unit 13 has a plurality of exit perforations 19 formed on the wall surface of the exit tube 25 at locations where two filter elements 15 are spaced-apart by intermediate screen members 23. The exit tube 25 is connected to an exit outlet 22. The exit tube 25 is also connected to a lower flange member 10. The lower flange member 10 prevents the bypass flow of fluids from the elongate body container 4 into the outlet reservoir 6. The upper end of the center filter unit 13 includes an upper flange 9 and its exit tube 25 further extends into the inlet reservoir separator 7 into inlet reservoir 5, where screw 11 is provided to prevent entry of contaminated fluid into exit tube 25 and further seal inlet reservoir separator against the top of all filter units 13.

Accordingly, the present invention can accommodate greater flow rates and volume of circulating liquids. The present invention can be used to filter the oil of large internal combustion engines, such as those used in boats, aircrafts, locomotives, and jet aircrafts. Furthermore, the present invention can recycle large volume of contaminated liquids or dirty cleaning fluid solvents from a machinery reservoir. Thus, the present invention may be used to filter and recycle wastewaters from food, chemical, manufacturing, and gasoline industries.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments of the foregoing description, but rather is indicated by the appended claims. All changes that come within the meaning and range of equivalents within the claims are intended to be considered as being embraced within the spirit and scope of the claims.

What is claimed is:

1. A filtering apparatus for contaminated fluids comprising:
an elongated container body having a wall, a top plane and outlet reservoir separator defining a chamber to retain contaminated fluid;
an inlet reservoir situated above the top plane;
a removable inlet reservoir baffle separating the inlet reservoir from the elongate container body;
an outlet reservoir situated beneath the elongated container body under the outlet reservoir separator for receiving filtered fluid;
an inlet integrally connected and extruding outward from the inlet reservoir;
an outlet integrally connected to and extruding outward from the outlet reservoir;
a central conduit running along an axial length of the container body, extending upward from the outlet reservoir separator;
a plurality of removable cylindrical filter units symmetrically positioned in the container body below the baffle and above the outlet reservoir separator;
a plurality of exit tubes, each tube surrounded by a filter unit and extending upward from the outlet reservoir separator along the axial length of a filter unit;
wherein a large volume of contaminated fluid is filtered through the apparatus by entering the inlet, flowing into the inlet reservoir, through the inlet reservoir baffle, into the container body, filtering through the filter units, and wherein filtered fluid exits into the outlet reservoir from the exit tubes and through the outlet:

2. The filtering apparatus according to claim 1, further comprising a cylindrical axial conduit surrounded by each filter unit and running along its entire axial length, said axial conduit surrounding the exit tube, and having a plurality of openings formed on the circumference of a wall surface of said axial conduit.

3. The filtering apparatus according to claim 2, further comprising a plurality of slots formed on a wall surface of said exit tube, said slots situated above or below the plane at which the openings of the axial conduit are provided, said exit tube at a lower end being in fluid communication with the outlet reservoir through a plurality of exit openings on the outlet reservoir separator each exit opening directly beneath an exit tube;

4. The filtering apparatus as in claim 1, wherein each of the filtering units further comprises at least four co-axially stacked and vertically spaced-apart filter elements mounted in a filter cartridge such that one end of each filter element is in fluid communication with the contaminated fluid contained in said elongate container body.

5. The filtering apparatus as in claim 3, wherein each of the filtering units holds at least a pair of co-axially stacked and vertically spaced-apart filter elements mounted in a filter cartridge such that one end of each filter element is in fluid communication with the contaminated fluid contained in said elongate container body.

6. The filtering apparatus as in claim 5, wherein a plurality of entry openings are formed on a wall surface of each filter cartridge, at circumferential locations where two filter elements are vertically spaced-apart, so as to further provide fluid communication to the filter elements from contaminated fluid in the container body.

7. The filtering apparatus as in claim 5, wherein said filter cartridge is composed of a thick material made from cellulose fiber or cardboard.

8. The filtering apparatus as in claim 6, wherein each of said filter elements comprise a spun roll of filtering paper around a cylindrical tube, said tube defining a central axial passageway surrounding the axial conduit of the filtering unit.

9. The filtering apparatus as in claim 6, wherein a plurality of mesh separators are placed between the stacked filter elements.

10. The filtering apparatus as in claim 9, comprising four filter elements co-axially stacked and vertically separated by a plurality of mesh separators between each stacked filter element, the four filter elements defined from top to bottom as element A, element B, element C and element D, wherein the entry openings on the filter cartridge are provided at a middle point of the unit, in line with the mesh separators between element B and element C, wherein the openings on the axial conduit are provided at a circumference in line with the mesh separators between element A and element B and at a circumference in line with the mesh separators between element C and element D, wherein the diameter of the entry openings and openings on the axial conduit are no larger than the height of the mesh separators between each stacked filter element.

11. The filtering apparatus as in claim 9, wherein a flange member is removably attached to a bottom side of the baffle, at an upper end of the axial conduit of each filtering unit, wherein the flange member prevents a bypass of fluid flow into the axial conduit.

12. The filtering apparatus of claim 11, wherein a lower flange member is removably mounted to an upper side of the outlet reservoir separator at a lower end of the axial conduit of each filtering unit, wherein the lower flange member prevents a bypass of fluid flow into the axial conduit and prevents a bypass of fluid flow into the outlet reservoir.

13. The filtering apparatus of claim 12 having three filter units, triangularly and symmetrically mounted in the elongate container body.

14. The filtering apparatus of claim 12, having four filter units symmetrically mounted in the elongate container body.

15. The filtering apparatus of claim 12, having seven filter units symmetrically mounted in the elongate container body, such that six filter units symmetrically surround a center filter unit, the center filter unit having its exit tube serve as the central conduit.

16. The filtering apparatus of claim 1, further comprising a removable upper lid on top of the elongated container body.

17. The filtering apparatus of claim 16, further comprising a pressure regulator provided on the removable upper lid, having an automatic release valve for releasing a pressure of fluid inside the container body; and
a gauge provided on the removable upper lid for determining the pressure of the fluid inside the container body and for indicating a saturation level of the filtering units.

18. The filtering apparatus of claim 16, further comprising a fastening means for securely connecting the removable lid to the container body.

19. The filtering apparatus as in claim 1, wherein there is a plurality of perforations in the inlet reservoir baffle.

20. The filtering apparatus as in claim 1, further comprising a fastening means to secure the baffle on a top of the filtering units.

21. The filtering apparatus for fluids according to claim 1, wherein the elongated body comprises aluminum, cold-steel of stainless steel.

22. A filtering apparatus for contaminated fluids comprising:
a removable upper lid;
an elongated container body having a wall, a top plane and outlet reservoir separator defining a chamber to retain contaminated fluid;
an inlet reservoir situated beneath the upper lid and above the top plane;
a removable inlet reservoir baffle separating the inlet reservoir from the elongate container body;
an outlet reservoir situated beneath the elongated container body under the outlet reservoir separator for receiving filtered fluid;
an inlet integrally connected and extruding outward from the inlet reservoir;
an outlet integrally connected to and extruding outward from the outlet reservoir;
a central conduit running along an axial length of the container body, extending upward from the outlet reservoir separator;
a plurality of removable cylindrical filter units symmetrically positioned in the container body below the baffle and above the outlet reservoir separator;
a plurality of exit tubes, each tube surrounded by a filter unit and extending upward from the outlet reservoir separator along the axial length of a filter unit;
an upper flange mounted above and into each filter unit and a lower flange mounted beneath and into each filter unit, wherein each flange seals the center of each filter unit from bypass flow of contaminated fluid;
wherein a top end of the central conduit extends into the inlet reservoir through the center of the baffle and having a threaded connection, said central conduit is capped off by a removable screw
wherein the baffle is secured upon the filtering units; and
wherein a large volume and flow rate of contaminated fluid is filtered through the apparatus.

23. The filtering apparatus of claim 22, wherein each filtering unit further comprises a cylindrical axial conduit surrounded by each filter unit and running along its entire axial length, said axial conduit surrounding the exit tube, and having a plurality of openings formed on the circumference of a wall surface of said axial conduit.

24. The filtering apparatus as in claim 23, wherein each of the filtering units holds at least a pair of co-axially stacked and vertically spaced-apart filter elements mounted in a filter cartridge such that one end of each filter element is in fluid communication with the contaminated fluid contained in said elongate container body.

25. The filtering apparatus as in claim 24, wherein each of said filter elements comprise a spun roll of filtering paper around a cylindrical tube, said tube defining a central axial passageway surrounding the axial conduit of the filtering unit.

26. A filtering apparatus for fluids comprising:
(a) a removable upper lid;
(b) an elongated container body having a wall, a top plane and outlet reservoir separator defining a chamber to retain contaminated fluid;
(c) a fastening means for securely connecting the removable lid to the container body;
(d) an inlet reservoir situated beneath the upper lid and above the top plane, wherein there is a plurality of perforations on the surface of said inlet reservoir separator;
(e) a removable inlet reservoir baffle separating the inlet reservoir from the elongate container body;
(f) an outlet reservoir situated beneath the elongated container body under the outlet reservoir separator for receiving filtered fluid;
(g) an inlet integrally connected and extruding outward from the inlet reservoir;
(h) an outlet integrally connected and extruding outward from a bottom surface of the outlet reservoir;
(i) a central conduit situated along the entire axial length of the elongate container body, wherein the central conduit extends into the inlet reservoir and is capped off by a removable screw;
(i) an outlet reservoir separator separating the outlet reservoir from the elongate container body, wherein there are openings on a surface of said outlet reservoir separator;
(j) at least two filter units, each unit having
(i) an axial conduit situated along its entire axial length,
(ii) a plurality of openings are formed on a wall surface of said axial conduit and said axial conduit having an upper and lower end,
(iii) an upper flange member removably attached to the inlet reservoir separator at the upper end of said axial conduit, preventing a bypass of fluid flow into the axial conduit,
(iv) an exit tube inside the axial conduit, having a plurality of slots for filtered fluid to enter, said exit tube at the lower end aligned with an opening on the outlet reservoir separator,
(v) a lower flange member mounted to the outlet reservoir separator above the opening and connected at the lower end of the axial conduit, preventing a bypass of fluid flow into the outlet reservoir and axial conduit,
(vi) two or more filter elements co-axially stacked, vertically spaced apart, and encased in a filter cartridge having a plurality of perforations on the wall surface of said filter cartridge at the location where two or filter elements are vertically spaced apart;
(k) a pressure regulator provided on the removable upper lid, having an automatic release valve for releasing a pressure of fluid inside the container body; and
(l) a gauge provided on the removable upper lid for determining the pressure of the fluid inside the container body and for indicating a saturation level of the filtering units;
wherein a large volume of contaminated fluid is filtered through the apparatus by entering the inlet, flowing into the inlet reservoir, through the inlet reservoir baffle, into the container body, filtering through the filter units, and wherein filtered fluid exits into the outlet reservoir from the exit tubes and through the outlet.

27. The filtering apparatus of claim 26, further comprising handles on the wall surface of the container body for maneuvering the apparatus.

28. The filtering apparatus of claim 26, having a set of stands connected to a bottom surface of the apparatus such that the apparatus is elevated.
